(19) United States
(12) Patent Application Publication
(10) Pub. No.: US 2025/0374311 A1
(43) Pub. Date: Dec. 4, 2025

(54) TECHNIQUES FOR COMMUNICATING WITH UPLINK-ONLY CELL

(71) Applicant: QUALCOMM Incorporated, San Diego, CA (US)

(72) Inventors: Yiqing CAO, Beijing (CN); Peter GAAL, San Diego, CA (US); Hung Dinh LY, San Diego, CA (US)

(21) Appl. No.: 18/872,931

(22) PCT Filed: Aug. 12, 2022
(86) PCT No.: PCT/CN2022/112129

§ 371 Date: Dec. 9, 2024

(51) Int. Cl. H04W 72/51; H04L 1/1812; H04L 5/14; H04W 72/0446; H04W 72/12; H04W 76/20

(52) U.S. Cl. CPC H04W 72/51; H04L 1/1812; H04L 5/1469; H04W 72/0446; H04W 72/12; H04W 76/20

(57) ABSTRACT

Various aspects of the present disclosure generally relate to wireless communication. In some aspects, a user equipment (UE) may transmit UE capability information indicative of a capability of the UE to support communications with an uplink-only cell. The UE may receive, from a network node associated with a primary cell and based on transmitting the UE capability information, configuration information corresponding to a carrier aggregation framework including the primary cell and an uplink-only cell. The UE may transmit, to a network node associated with the uplink-only cell and based on the configuration information, an uplink communication. Numerous other aspects are described.

### FIELD OF THE DISCLOSURE

Aspects of the present disclosure generally relate to wireless communication and to techniques and apparatuses for communicating with an uplink-only cell.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to a method of wireless communication performed by a user equipment (UE). The method may include transmitting UE capability information indicative of a capability of the UE to support communications with an uplink-only cell. The method may include receiving, from a network node associated with a primary cell and based on transmitting the UE capability information, configuration information corresponding to a carrier aggregation framework including the primary cell and an uplink-only cell. The method may include transmitting, to a network node associated with the uplink-only cell and based on the configuration information, an uplink communication.

Some aspects described herein relate to a method of wireless communication performed by a network node. The method may include receiving UE capability information indicative of a capability of a UE to support communications with an uplink-only cell, wherein the network node is associated with a primary cell. The method may include transmitting, based on receiving the UE capability information, configuration information corresponding to a carrier aggregation framework including the primary cell and an uplink-only cell.

Some aspects described herein relate to a UE for wireless communication. The UE may include a memory and one or more processors coupled to the memory. The one or more processors may be configured to transmit UE capability information indicative of a capability of the UE to support communications with an uplink-only cell. The one or more processors may be configured to receive, from a network node associated with a primary cell and based on transmitting the UE capability information, configuration information corresponding to a carrier aggregation framework including the primary cell and an uplink-only cell. The one or more processors may be configured to transmit, to a network node associated with the uplink-only cell and based on the configuration information, an uplink communication.

Some aspects described herein relate to a network node for wireless communication. The network node may include a memory and one or more processors coupled to the memory. The one or more processors may be configured to receive UE capability information indicative of a capability of a UE to support communications with an uplink-only cell, wherein the network node is associated with a primary cell. The one or more processors may be configured to transmit, based on receiving the UE capability information, configuration information corresponding to a carrier aggregation framework including the primary cell and an uplink-only cell.

Some aspects described herein relate to a non-transitory computer-readable medium that stores a set of instructions for wireless communication by a UE. The set of instructions, when executed by one or more processors of the UE, may cause the UE to transmit UE capability information indicative of a capability of the UE to support communications with an uplink-only cell. The set of instructions, when executed by one or more processors of the UE, may cause the UE to receive, from a network node associated with a primary cell and based on transmitting the UE capability information, configuration information corresponding to a carrier aggregation framework including the primary cell and an uplink-only cell. The set of instructions, when executed by one or more processors of the UE, may cause the UE to transmit, to a network node associated with the uplink-only cell and based on the configuration information, an uplink communication.

Some aspects described herein relate to a non-transitory computer-readable medium that stores a set of instructions for wireless communication by a network node. The set of instructions, when executed by one or more processors of the network node, may cause the network node to receive UE capability information indicative of a capability of a UE to support communications with an uplink-only cell, wherein the network node is associated with a primary cell. The set of instructions, when executed by one or more processors of the network node, may cause the network node to transmit, based on receiving the UE capability information, configuration information corresponding to a carrier aggregation framework including the primary cell and an uplink-only cell.

Some aspects described herein relate to an apparatus for wireless communication. The apparatus may include means for transmitting UE capability information indicative of a capability of the apparatus to support communications with an uplink-only cell. The apparatus may include means for receiving, from a network node associated with a primary cell and based on transmitting the UE capability information, configuration information corresponding to a carrier aggregation framework including the primary cell and an uplink-only cell. The apparatus may include means for transmitting, to a network node associated with the uplink-only cell and based on the configuration information, an uplink communication.

Some aspects described herein relate to an apparatus for wireless communication. The apparatus may include means for receiving UE capability information indicative of a capability of a UE to support communications with an uplink-only cell, wherein the apparatus is associated with a primary cell. The apparatus may include means for transmitting, based on receiving the UE capability information, configuration information corresponding to a carrier aggregation framework including the primary cell and an uplink-only cell.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of communicating with an uplink-only cell, in accordance with the present disclosure.

FIG. 5 is a diagram illustrating an example process performed, for example, by a UE, in accordance with the present disclosure.

FIG. 6 is a diagram illustrating an example process performed, for example, by a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

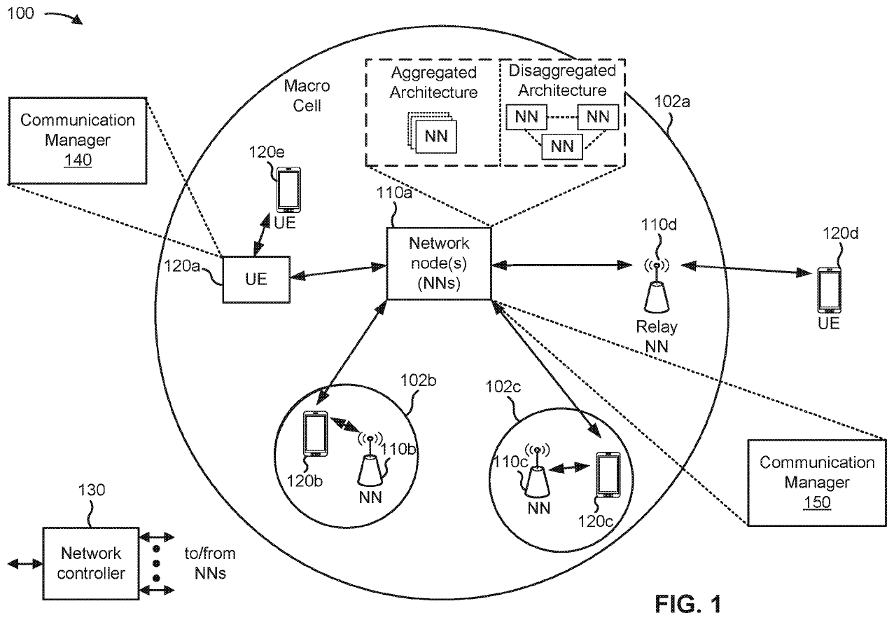

FIG. 1 is a diagram illustrating an example of a wireless network 100, in accordance with the present disclosure. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120e), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUS)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node)

In some aspects, the term “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the term “base station” or “network node” may refer to one device configured to perform one or more functions, such as those described herein in connection with the network node 110. In some aspects, the term “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the term “base station” or “network node” may refer to any one or more of those different devices. In some aspects, the term “base station” or “network node” may refer to one or more virtual base stations or one or more virtual base station functions. For example, in some aspects, two or more base station functions may be instantiated on a single device. In some aspects, the term “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, a drone, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120e) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the

electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHZ). Although a portion of FRI is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHZ,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, the UE 120 may include a communication manager 140. As described in more detail elsewhere herein, the communication manager 140 may transmit UE capability information indicative of a capability of the UE to support communications with an uplink-only cell; receive, from a network node associated with a primary cell and based on transmitting the UE capability information, configuration information corresponding to a carrier aggregation framework including the primary cell and an uplink-only cell; and transmit, to a network node associated with the uplink-only cell and based on the configuration information, an uplink communication. Additionally, or alternatively, the communication manager 140 may perform one or more other operations described herein.

In some aspects, the network node 110 may include a communication manager 150. As described in more detail elsewhere herein, the communication manager 150 may receive UE capability information indicative of a capability of a UE to support communications with an uplink-only cell, wherein the network node is associated with a primary cell; and transmit, based on receiving the UE capability information, configuration information corresponding to a carrier aggregation framework including the primary cell and an uplink-only cell. Additionally, or alternatively, the communication manager 150 may perform one or more other operations described herein.

As indicated above, FIG. 1 is provided as an example. Other examples may differ from what is described with regard to FIG. 1.

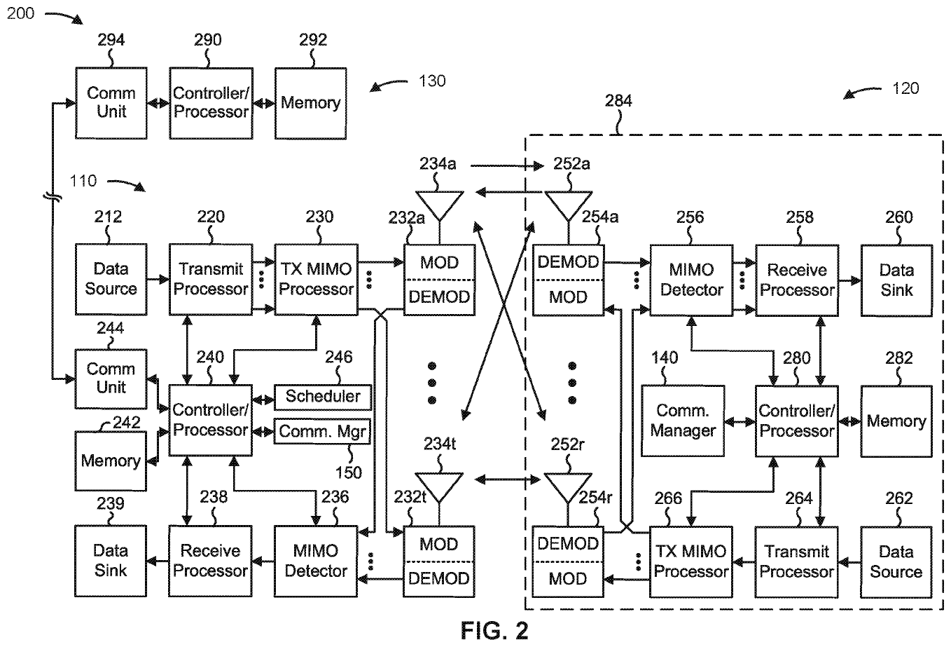

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 254. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A transmit (TX) multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

Each of the antenna elements may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, or other types of antennas arranged in a linear pattern, a two-dimensional pattern, or another pattern. A spacing between antenna elements may be such that signals with a desired wavelength transmitted separately by the antenna elements may interact or interfere (e.g., to form a desired beam). For example, given an expected range of wavelengths or frequencies, the spacing may provide a quarter wavelength, half wavelength, or other fraction of a wavelength of spacing between neighboring antenna elements to allow for interaction or interference of signals transmitted by the separate antenna elements within that expected range.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

A beam indication may be, or include, a TCI state information element, a beam identifier (ID), spatial relation information, a TCI state ID, a closed loop index, a panel ID, a TRP ID, and/or a sounding reference signal (SRS) set ID, among other examples. A TCI state information element (referred to as a TCI state herein) may indicate information associated with a beam such as a downlink beam. For example, the TCI state information element may indicate a TCI state identification (e.g., a tci-StateID), a quasi-co-location (QCL) type (e.g., a qcl-Type 1, qcl-Type2, qcl-TypeA, qcl-TypeB, qcl-TypeC, qcl-TypeD, and/or the like), a cell identification (e.g., a ServCellIndex), a bandwidth part identification (bwp-Id), a reference signal identification such as a CSI-RS (e.g., an NZP-CSI-RS-ResourceId, an SSB-Index, and/or the like), and/or the like. Spatial relation information may similarly indicate information associated with an uplink beam.

The beam indication may be a joint or separate downlink (DL)/uplink (UL) beam indication in a unified TCI framework. In some cases, the network may support layer 1 (L1)-based beam indication using at least UE-specific (unicast) downlink control information (DCI) to indicate joint or separate DL/UL beam indications from active TCI states. In some cases, existing DCI formats 1_1 and/or 1_2 may be reused for beam indication. The network may include a support mechanism for a UE to acknowledge successful decoding of a beam indication. For example, the acknowledgment/negative acknowledgment (ACK/NACK) of the PDSCH scheduled by the DCI carrying the beam indication may be also used as an ACK for the DCI.

Beam indications may be provided for carrier aggregation (CA) scenarios. In a unified TCI framework, information the network may support common TCI state ID update and activation to provide common QCL and/or common UL transmission spatial filter or filters across a set of configured component carriers (CCs). This type of beam indication may apply to intra-band CA, as well as to joint DL/UL and separate DL/UL beam indications. The common TCI state ID may imply that one reference signal (RS) determined according to the TCI state(s) indicated by a common TCI state ID is used to provide QCL Type-D indication and to determine UL transmission spatial filters across the set of configured CCs.

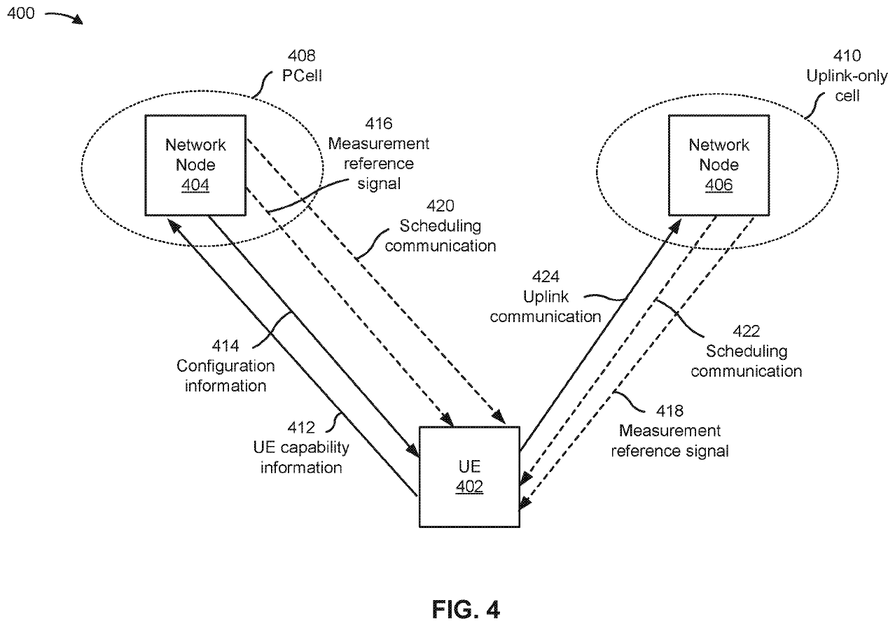

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a TX MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the TX MIMO processor 266. The transceiver may be used by a processor (for example, the controller/processor 280) and the memory 282 to perform aspects of any of the processes described herein (e.g., with reference to FIGS. 4-8).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the TX MIMO processor 230. The transceiver may be used by a processor (for example, the controller/processor 240) and the memory 242 to perform aspects of any of the processes described herein (e.g., with reference to FIGS. 4-8).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

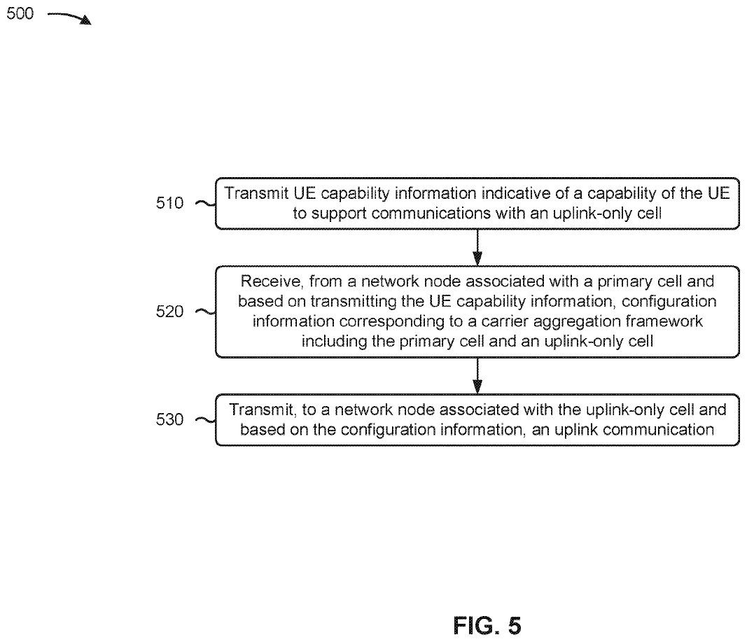

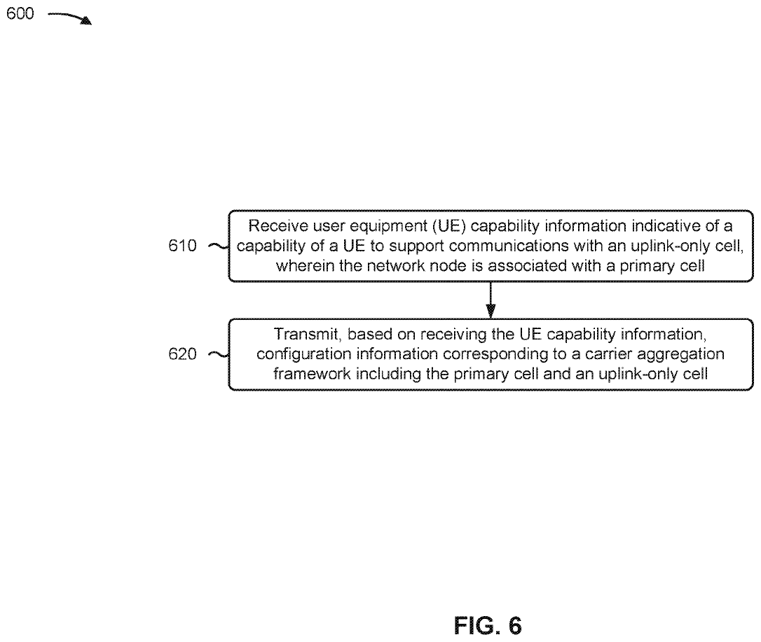

The controller/processor 240 of the network node 110, the controller/processor 280 of the UE 120, or any other component(s) of FIG. 2 may perform one or more techniques associated with communicating with an uplink-only cell, as described in more detail elsewhere herein. For example, the controller/processor 240 of the network node 110, the controller/processor 280 of the UE 120, or any other component(s) (or combinations of components) of FIG. 2 may perform or direct operations of, for example, process 500 of FIG. 5, process 600 of FIG. 6, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, the UE 120 includes means for transmitting UE capability information indicative of a capability of the UE to support communications with an uplink-only cell; means for receiving, from a network node associated with a primary cell and based on transmitting the UE capability information, configuration information corresponding to a carrier aggregation framework including the primary cell and an uplink-only cell; and/or means for transmitting, to a network node associated with the uplink-only cell and based on the configuration information, an uplink communication. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving UE capability information indicative of a capability of a UE to support communications with an uplink-only cell, wherein the network node is associated with a primary cell; and/or means for transmitting, based on receiving the UE capability information, configuration information corresponding to a carrier aggregation framework including the primary cell and an uplink-only cell. In some aspects, the means for the network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

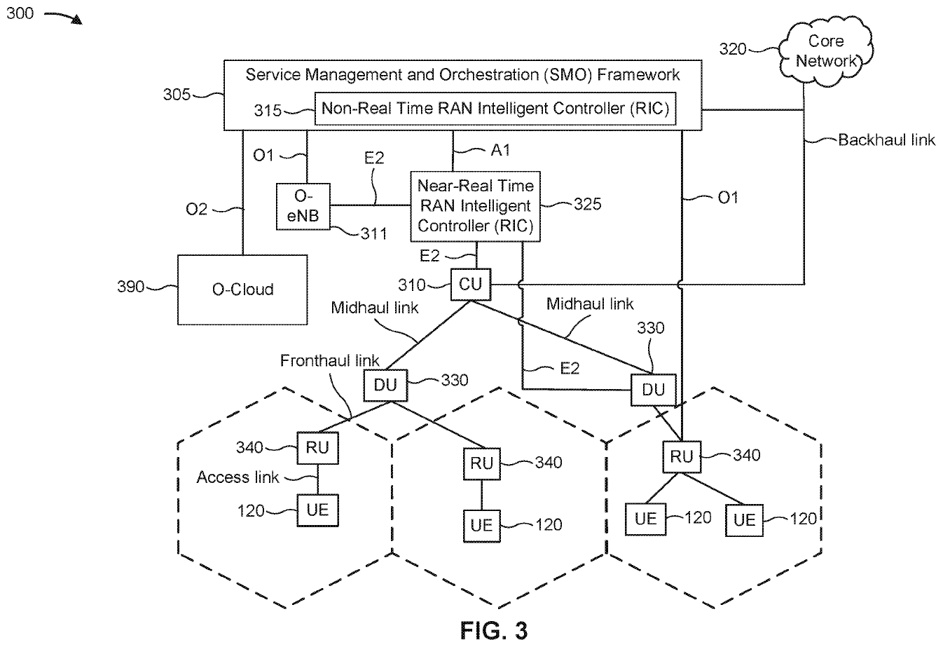

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUS 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the El interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an Al interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as Al interface policies).

As indicated above, FIG. 3 is provided as an example. Other examples may differ from what is described with regard to FIG. 3.

Some regulators define indoor-only spectrums (e.g. 2.3 GHZ) to avoid interference to other neighboring incumbent services. The indoor-only spectrum can be used for outdoor communications if a mobile network carrier obtains allowance from the incumbent service. In some cases, an indoor-only spectrum can be configured as an uplink-only spectrum to mitigate potential interference with neighboring services. For example, a carrier aggregation based solution can be used to activate an uplink-only cell (e.g., a secondary cell (SCell)). However, to do so, a number of parameters and functionalities associated with the uplink-only cell should be provided to a UE.

Some aspects of the techniques and apparatuses described herein may facilitate communication with an uplink-only cell. In some aspects, for example, a UE may transmit, to a network node associated with a PCell, UE capability information indicative of a capability of the UE to support communications with an uplink-only cell. The UE may receive, from the network node associated with the PCell and based on transmitting the UE capability information, configuration information. The configuration information may correspond to a carrier aggregation framework including the PCell and an uplink-only cell. The UE may transmit, to a network node associated with the uplink-only cell and based on the configuration information, an uplink communication. In this way, some aspects of the techniques described herein may facilitate communication with an uplink-only cell, thereby expanding the offering of bands available for communication, which may positively impact network performance and user experience quality.

FIG. 4 is a diagram illustrating an example 400 of communicating with an uplink-only cell, in accordance with the present disclosure. As shown in FIG. 4, a UE 402 may communicate with a network node 404 and a network node 406. In some aspects, the UE 402 may be, be similar to, include, or be included in, the UE 120 depicted in FIGS. 1-3. In some aspects, the network node 404 and/or the network node 406 may be, be similar to, include, or be included in, the network node 110 depicted in FIGS. 1 and 2 and/or one or more components of the disaggregated base station architecture depicted in FIG. 3.

In some aspects, as shown, the network node 404 may be associated with a PCell 408, and the network node 406 may be associated with an uplink-only cell 410. For example, in some aspects, the network node 404 may provide the PCell 408, and the network node 406 may provide the uplink-only cell 410. The PCell 408 may support uplink and downlink communications. In some aspects, the uplink-only cell may be an SCell.

As shown by reference number 412, the network node 404 may transmit, and the UE 402 may receive, UE capability information. The UE capability information may be indicative of a capability of the UE to support communications with an uplink-only cell. As shown by reference number 414, the network node 404 may transmit, and the UE 402 may receive, configuration information. The network node 404 may transmit, and the UE may receive, the configuration information based on the reception and transmission, respectively, of the UE capability information. In some aspects, the configuration information may correspond to a carrier aggregation framework including the primary cell and an uplink-only cell. In some aspects, the carrier aggregation framework may include any number of additional cells (e.g., uplink-only cells and/or cells that support both uplink and downlink communications).

In some aspects, the network node 404 may transmit the configuration information using at least one of an RRC message or a medium access control (MAC) control element (MAC CE). In some aspects, the configuration information may indicate a dedicated band number associated only with the uplink-only cell. In some other aspects, the configuration information may indicate a band number associated with the uplink-only cell, where the band number is associated with one or more additional cells (e.g., one or more additional cells that support downlink and uplink communications).

In some aspects, the configuration information may be indicative of a band mode. The band mode may include a carrier aggregation associated with the PCell and the uplink-only cell. A band associated with the carrier aggregation may include a carrier aggregation band associated with uplink and downlink communications or an uplink-only band. In some aspects, the configuration information may include an explicit indication of the band mode. In some other aspects, the configuration information may implicitly indicate the band mode based on at least one of an uplink slot configuration or a resource schedule. The uplink slot configuration may correspond only to uplink slots. In some aspects, the configuration information may include a downlink slot configuration, where the resource schedule corresponds only to uplink slots.

In some aspects, the configuration information may be indicative of a time division duplex (TDD) frame structure. The TDD frame structure may indicate at least one downlink slot, at least one special slot, and at least one uplink slot. For example, the configuration information may configure the UE 402 to operate in an uplink-only mode, which may include refraining from communicating on a downlink slot of the at least one downlink slot and any downlink symbol of the at least one special slot. In some aspects, the TDD frame structure may indicate only uplink slots. In some aspects, the configuration information may be indicative of a frequency division duplex (FDD) frame structure that indicates only uplink slots.

In some aspects, the configuration information may be indicative of a MAC based activation configuration, associated with the uplink-only cell, for activating and/or deactivating communications. An activation delay value associated with the MAC based activation configuration may be less than an activation delay value for an activation configuration associated with a cell that supports uplink and downlink communications. In some aspects, the configuration information may be indicative of support for simultaneous uplink communication to the uplink-only cell and one or more other cells. For example, the UE capability information may indicate that the UE supports multiple uplink-only cell communication and, based on that indication, the configuration information may indicate the support for simultaneous uplink communications to multiple uplink-only cells. In some aspects, the configuration information may indicate that the uplink-only cell does not support spatial relations. In some aspects, the configuration information may indicate that initial access associated with the uplink-only cell is not supported.

In some aspects, the uplink-only cell may be associated with a timing advance group (TAG) that includes at least one additional cell. The at least one additional cell may support uplink and downlink communications. In some aspects, the configuration information may be indicative of a hybrid automatic repeat request (HARQ) configuration. The HARQ configuration may correspond only to the uplink-only cell. The HARQ configuration may indicate at least one of a HARQ identifier corresponding only to the uplink-only cell or a HARQ procedure corresponding only to the uplink-only cell.

As shown by reference number 416, the network node 404 may transmit, and the UE 402 may receive, a measurement reference signal. The measurement reference signal may be configured for measuring, by the UE 402, one or more metrics associated with communicating with the uplink-only cell. In some aspects, as shown by reference number 418, the network node 406 may transmit, and the UE 402 may receive a measurement reference signal. In some aspects, the measurement reference signal may include a path-loss reference signal.

As shown by reference number 420, the network node 404 may transmit, and the UE 402 may receive, a scheduling communication. As shown by reference number 422, the network node 406 ay transmit, and the UE 402 may receive, a scheduling communication. The scheduling communication may schedule one or more uplink resources associated with communicating with the uplink-only cell. For example, the scheduling communication may include downlink control information. In some aspects, a random access channel (RACH) transmission may be supported by the uplink-only cell, with downlink RACH messages being provided by the network node 404. In some aspects, the RACH communications may be configured according to a cross-carrier scheduling involving the network node 404 and the network node 406. In some aspects, the RACH transmission may be associated with a non-contention based RACH operation.

As shown by reference number 424, the UE 402 may transmit, and the network node 406 may receive, an uplink communication. The UE 402 may transmit, and the network node 406 may receive, the uplink communication based on the configuration information.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 402) performs operations associated with techniques for communicating with an uplink-only cell.

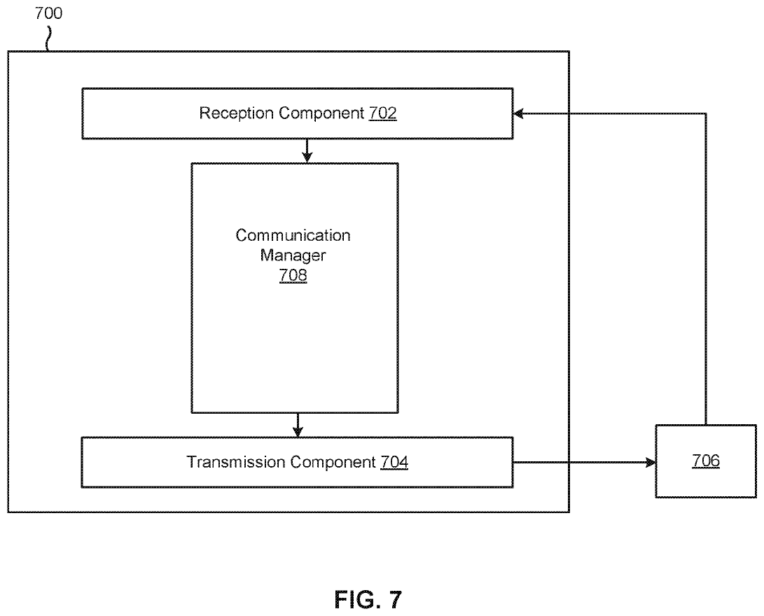

As shown in FIG. 5, in some aspects, process 500 may include transmitting UE capability information indicative of a capability of the UE to support communications with an uplink-only cell (block 510). For example, the UE (e.g., using communication manager 708 and/or transmission component 704, depicted in FIG. 7) may transmit UE capability information indicative of a capability of the UE to support communications with an uplink-only cell, as described above.

As further shown in FIG. 5, in some aspects, process 500 may include receiving, from a network node associated with a primary cell and based on transmitting the UE capability information, configuration information corresponding to a carrier aggregation framework including the primary cell and an uplink-only cell (block 520). For example, the UE (e.g., using communication manager 708 and/or reception component 702, depicted in FIG. 7) may receive, from a network node associated with a primary cell and based on transmitting the UE capability information, configuration information corresponding to a carrier aggregation framework including the primary cell and an uplink-only cell, as described above.

As further shown in FIG. 5, in some aspects, process 500 may include transmitting, to a network node associated with the uplink-only cell and based on the configuration information, an uplink communication (block 530). For example, the UE (e.g., using communication manager 708 and/or transmission component 704, depicted in FIG. 7) may transmit, to a network node associated with the uplink-only cell and based on the configuration information, an uplink communication, as described above.

Process 500 may include additional aspects, such as any single aspect or any combination of aspects described below and/or in connection with one or more other processes described elsewhere herein.

In a first aspect, the configuration information indicates a dedicated band number associated only with the uplink-only cell. In a second aspect, alone or in combination with the first aspect, the configuration information indicates a band number associated with the uplink-only cell, wherein the band number is associated with one or more additional cells. In a third aspect, alone or in combination with one or more of the first and second aspects, the configuration information is indicative of a band mode, the band mode comprising a carrier aggregation associated with the primary cell and the uplink-only cell, wherein a band associated with the carrier aggregation comprises a carrier aggregation band associated with uplink and downlink communications or an uplink-only band. In a fourth aspect, alone or in combination with the third aspect, the configuration information comprises an explicit indication of the band mode. In a fifth aspect, alone or in combination with the third aspect, the configuration information implicitly indicates the band mode based on at least one of an uplink slot configuration or a resource schedule. In a sixth aspect, alone or in combination with the fifth aspect, the uplink slot configuration corresponds only to uplink slots. In a seventh aspect, alone or in combination with the fifth aspect, the configuration information further comprises a downlink slot configuration, wherein the resource schedule corresponds only to uplink slots.

In an eighth aspect, alone or in combination with one or more of the first through seventh aspects, the configuration information is indicative of a TDD frame structure. In a ninth aspect, alone or in combination with the eighth aspect, the TDD frame structure indicates at least one downlink slot, at least one special slot, and at least one uplink slot. In a tenth aspect, alone or in combination with the ninth aspect, process 500 includes operating in an uplink-only mode, wherein operating in the uplink-only mode comprises refraining from communicating on a downlink slot of the at least one downlink slot and any downlink symbol of the at least one special slot. In an eleventh aspect, alone or in combination with the eighth aspect, the TDD frame structure indicates only uplink slots.

In a twelfth aspect, alone or in combination with one or more of the first through eleventh aspects, the configuration information is indicative of a frequency division duplex frame structure that indicates only uplink slots. In a thirteenth aspect, alone or in combination with one or more of the first through twelfth aspects, the uplink-only cell is an SCell. In a fourteenth aspect, alone or in combination with one or more of the first through thirteenth aspects, the configuration information is indicative of a MAC based activation configuration, associated with the uplink-only cell, for activating and/or deactivating communications. In a fifteenth aspect, alone or in combination with the fourteenth aspect, an activation delay value associated with the MAC based activation configuration is less than an activation delay value for an activation configuration associated with a cell that supports uplink and downlink communications.

In a sixteenth aspect, alone or in combination with one or more of the first through fifteenth aspects, the configuration information is indicative of support for simultaneous uplink communication to the uplink-only cell and one or more other cells. In a seventeenth aspect, alone or in combination with one or more of the first through sixteenth aspects, the UE capability information indicates that the UE supports communication with multiple uplink-only cells.

In an eighteenth aspect, alone or in combination with one or more of the first through seventeenth aspects, the configuration information indicates that the uplink-only cell does not support spatial relations. In a nineteenth aspect, alone or in combination with one or more of the first through eighteenth aspects, the configuration information indicates that initial access associated with the uplink-only cell is not supported. In a twentieth aspect, alone or in combination with one or more of the first through nineteenth aspects, the uplink-only cell is associated with a TAG that includes at least one additional cell, wherein the at least one additional cell supports uplink and downlink communications. In a twenty-first aspect, alone or in combination with one or more of the first through twentieth aspects, the configuration information is indicative of a HARQ configuration, the HARQ configuration corresponding only to the uplink-only cell. In a twenty-second aspect, alone or in combination with the twenty-first aspect, the HARQ configuration indicates at least one of a HARQ identifier corresponding only to the uplink-only cell or a HARQ procedure corresponding only to the uplink-only cell.

In a twenty-third aspect, alone or in combination with one or more of the first through twenty-second aspects, receiving the configuration information comprises receiving at least one of an RRC message or a MAC CE. In a twenty-fourth aspect, alone or in combination with one or more of the first through twenty-third aspects, process 500 includes receiving a measurement reference signal for measuring one or more metrics associated with communicating with the uplink-only cell. In a twenty-fifth aspect, alone or in combination with the twenty-fourth aspect, receiving the measurement reference signal comprises receiving the measurement reference signal from a primary cell or a secondary cell that supports uplink and downlink communications.

In a twenty-sixth aspect, alone or in combination with one or more of the first through twenty-fifth aspects, process 500 includes receiving a scheduling communication that schedules one or more uplink resources associated with communicating with the uplink-only cell. In a twenty-seventh aspect, alone or in combination with the twenty-sixth aspect, receiving the scheduling communication comprises receiving the scheduling communication from a primary cell or a secondary cell that supports uplink and downlink communications.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a network node, in accordance with the present disclosure. Example process 600 is an example where the network node (e.g., network node 404) performs operations associated with techniques for communicating with an uplink-only cell.

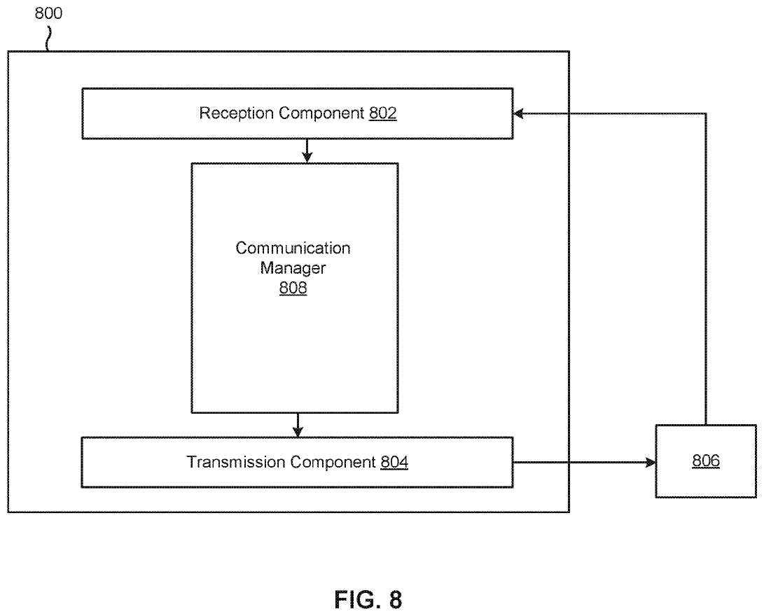

As shown in FIG. 6, in some aspects, process 600 may include receiving UE capability information indicative of a capability of a UE to support communications with an uplink-only cell, wherein the network node is associated with a primary cell (block 610). For example, the network node (e.g., using communication manager 808 and/or reception component 802, depicted in FIG. 8) may receive UE capability information indicative of a capability of a UE to support communications with an uplink-only cell, wherein the network node is associated with a primary cell, as described above.

As further shown in FIG. 6, in some aspects, process 600 may include transmitting, based on receiving the UE capability information, configuration information corresponding to a carrier aggregation framework including the primary cell and an uplink-only cell (block 620). For example, the network node (e.g., using communication manager 808 and/or transmission component 804, depicted in FIG. 8) may transmit, based on receiving the UE capability information, configuration information corresponding to a carrier aggregation framework including the primary cell and an uplink-only cell, as described above.

Process 600 may include additional aspects, such as any single aspect or any combination of aspects described below and/or in connection with one or more other processes described elsewhere herein.

In a first aspect, the configuration information indicates a dedicated band number associated only with the uplink-only cell. In a second aspect, alone or in combination with the first aspect, the configuration information indicates a band number associated with the uplink-only cell, wherein the band number is associated with one or more additional cells. In a third aspect, alone or in combination with one or more of the first and second aspects, the configuration information is indicative of a band mode, the band mode comprising a carrier aggregation associated with the primary cell and the uplink-only cell, wherein a band associated with the carrier aggregation comprises a carrier aggregation band associated with uplink and downlink communications or an uplink-only band. In a fourth aspect, alone or in combination with the third aspect, the configuration information comprises an explicit indication of the band mode. In a fifth aspect, alone or in combination with the third aspect, the configuration information implicitly indicates the band mode based on at least one of an uplink slot configuration or a resource schedule. In a sixth aspect, alone or in combination with the fifth aspect, the uplink slot configuration corresponds only to uplink slots. In a seventh aspect, alone or in combination with the fifth aspect, the configuration information further comprises a downlink slot configuration, wherein the resource schedule corresponds only to uplink slots.

In an eighth aspect, alone or in combination with one or more of the first through seventh aspects, the configuration information is indicative of a TDD frame structure. In a ninth aspect, alone or in combination with the eighth aspect, the TDD frame structure indicates at least one downlink slot, at least one special slot, and at least one uplink slot. In a tenth aspect, alone or in combination with the eighth aspect, the TDD frame structure indicates only uplink slots. In an eleventh aspect, alone or in combination with one or more of the first through tenth aspects, the configuration information is indicative of an FDD frame structure that indicates only uplink slots. In a twelfth aspect, alone or in combination with one or more of the first through eleventh aspects, the uplink-only cell is an SCell. In a thirteenth aspect, alone or in combination with one or more of the first through twelfth aspects, the configuration information is indicative of a MAC based activation configuration, associated with the uplink-only cell, for activating and/or deactivating communications. In a fourteenth aspect, alone or in combination with the thirteenth aspect, an activation delay value associated with the MAC based activation configuration is less than an activation delay value for an activation configuration associated with a cell that supports uplink and downlink communications.

In a fifteenth aspect, alone or in combination with one or more of the first through fourteenth aspects, the configuration information is indicative of support for simultaneous uplink communication to the uplink-only cell and one or more other cells. In a sixteenth aspect, alone or in combination with one or more of the first through fifteenth aspects, the UE capability information indicates that the UE supports communication with multiple uplink-only cells. In a seventeenth aspect, alone or in combination with one or more of the first through sixteenth aspects, the configuration information indicates that the uplink-only cell does not support spatial relations. In an eighteenth aspect, alone or in combination with one or more of the first through seventeenth aspects, the configuration information indicates that initial access associated with the uplink-only cell is not supported. In a nineteenth aspect, alone or in combination with one or more of the first through eighteenth aspects, the uplink-only cell is associated with a TAG that includes at least one additional cell, wherein the at least one additional cell supports uplink and downlink communications.

In a twentieth aspect, alone or in combination with one or more of the first through nineteenth aspects, the configuration information is indicative of a HARQ configuration, the HARQ configuration corresponding only to the uplink-only cell. In a twenty-first aspect, alone or in combination with the twentieth aspect, the HARQ configuration indicates at least one of a HARQ identifier corresponding only to the uplink-only cell or a HARQ procedure corresponding only to the uplink-only cell.

In a twenty-second aspect, alone or in combination with one or more of the first through twenty-first aspects, transmitting the configuration information comprises transmitting at least one of an RRC message or a MAC CE. In a twenty-third aspect, alone or in combination with one or more of the first through twenty-second aspects, process 600 includes transmitting a measurement reference signal for measuring one or more metrics associated with communicating with the uplink-only cell. In a twenty-fourth aspect, alone or in combination with one or more of the first through twenty-third aspects, process 600 includes transmitting a scheduling communication that schedules one or more uplink resources associated with communicating with the uplink-only cell.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a communication manager 708.

In some aspects, the apparatus 700 may be configured to perform one or more operations described herein in connection with FIG. 4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 2. Additionally, or alternatively, one or more components shown in FIG. 7 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 700. In some aspects, the reception component 702 may include one or more antennas, a modem, a demodulator, a MIMO detector, a receive processor, a controller/processor, a memory, or a combination thereof, of the UE described in connection with FIG. 2.

The transmission component 704 may transmit communications, such as reference signals, control information, data communications, or a combination thereof, to the apparatus 706. In some aspects, one or more other components of the apparatus 700 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modem, a modulator, a transmit MIMO processor, a transmit processor, a controller/processor, a memory, or a combination thereof, of the UE described in connection with FIG. 2. In some aspects, the transmission component 704 may be co-located with the reception component 702 in a transceiver.

The communication manager 708 and/or the transmission component 704 may transmit UE capability information indicative of a capability of the UE to support communications with an uplink-only cell. In some aspects, the communication manager 708 may include one or more antennas, a modem, a controller/processor, a memory, or a combination thereof, of the UE described in connection with FIG. 2. In some aspects, the communication manager 708 may include the reception component 702 and/or the transmission component 704. In some aspects, the communication manager 708 may be, be similar to, include, or be included in, the communication manager 140 depicted in FIGS. 1 and 2.

The communication manager 708 and/or the reception component 702 may receive, from a network node associated with a primary cell and based on transmitting the UE capability information, configuration information corresponding to a carrier aggregation framework including the primary cell and an uplink-only cell. The communication manager 708 and/or the transmission component 704 may transmit, to a network node associated with the uplink-only cell and based on the configuration information, an uplink communication.

The communication manager 708 and/or the transmission component 704 may operate in an uplink-only mode, wherein operating in the uplink-only mode comprises refraining from communicating on a downlink slot of the at least one downlink slot and any downlink symbol of the at least one special slot. The communication manager 708 and/or the reception component 702 may receive a measurement reference signal for measuring one or more metrics associated with communicating with the uplink-only cell. The communication manager 708 and/or the reception component 702 may receive a scheduling communication that schedules one or more uplink resources associated with communicating with the uplink-only cell.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802 and a transmission component 804, which may be in communication with one another (for example, via one or more buses and/or one or more other components). As shown, the apparatus 800 may communicate with another apparatus 806 (such as a UE, a base station, or another wireless communication device) using the reception component 802 and the transmission component 804. As further shown, the apparatus 800 may include a communication manager 808.

In some aspects, the apparatus 800 may be configured to perform one or more operations described herein in connection with FIG. 4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 2. Additionally, or alternatively, one or more components shown in FIG. 8 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 802 may receive communications, such as reference signals, control information, data communications, or a combination thereof, from the apparatus 806. The reception component 802 may provide received communications to one or more other components of the apparatus 800. In some aspects, the reception component 802 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 800. In some aspects, the reception component 802 may include one or more antennas, a modem, a demodulator, a MIMO detector, a receive processor, a controller/processor, a memory, or a combination thereof, of the network node described in connection with FIG. 2.

The transmission component 804 may transmit communications, such as reference signals, control information, data communications, or a combination thereof, to the apparatus 806. In some aspects, one or more other components of the apparatus 800 may generate communications and may provide the generated communications to the transmission component 804 for transmission to the apparatus 806. In some aspects, the transmission component 804 may perform signal processing on the generated communications (such as filtering, amplification, modulation, digital-to-analog conversion, multiplexing, interleaving, mapping, or encoding, among other examples), and may transmit the processed signals to the apparatus 806. In some aspects, the transmission component 804 may include one or more antennas, a modem, a modulator, a transmit MIMO processor, a transmit processor, a controller/processor, a memory, or a combination thereof, of the network node described in connection with FIG. 2. In some aspects, the transmission component 804 may be co-located with the reception component 802 in a transceiver.

The communication manager 808 and/or the reception component 802 may receive UE capability information indicative of a capability of a UE to support communications with an uplink-only cell, wherein the network node is associated with a primary cell. In some aspects, the communication manager 808 may include one or more antennas, a modem, a controller/processor, a memory, or a combination thereof, of the network node described in connection with FIG. 2. In some aspects, the communication manager 808 may include the reception component 802 and/or the transmission component 804. In some aspects, the communication manager 808 may be, be similar to, include, or be included in, the communication manager 150 depicted in FIGS. 1 and 2.

The communication manager 808 and/or the transmission component 804 may transmit, based on receiving the UE capability information, configuration information corresponding to a carrier aggregation framework including the primary cell and an uplink-only cell. The communication manager 808 and/or the transmission component 804 may transmit a measurement reference signal for measuring one or more metrics associated with communicating with the uplink-only cell. The communication manager 808 and/or the transmission component 804 may transmit a scheduling communication that schedules one or more uplink resources associated with communicating with the uplink-only cell.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:

Aspect 1: A method of wireless communication performed by a user equipment (UE), comprising: transmitting UE capability information indicative of a capability of the UE to support communications with an uplink-only cell; receiving, from a network node associated with a primary cell and based on transmitting the UE capability information, configuration information corresponding to a carrier aggregation framework including the primary cell and an uplink-only cell; and transmitting, to a network node associated with the uplink-only cell and based on the configuration information, an uplink communication.

Aspect 2: The method of Aspect 1, wherein the configuration information indicates a dedicated band number associated only with the uplink-only cell.

Aspect 3: The method of Aspect 1, wherein the configuration information indicates a band number associated with the uplink-only cell, wherein the band number is associated with one or more additional cells.

Aspect 4: The method of any of Aspects 1-3, wherein the configuration information is indicative of a band mode, the band mode comprising a carrier aggregation associated with the primary cell and the uplink-only cell, wherein a band associated with the carrier aggregation comprises a carrier aggregation band associated with uplink and downlink communications or an uplink-only band.

Aspect 5: The method of Aspect 4, wherein the configuration information comprises an explicit indication of the band mode.

Aspect 6: The method of Aspect 4, wherein the configuration information implicitly indicates the band mode based on at least one of an uplink slot configuration or a resource schedule.

Aspect 7: The method of Aspect 6, wherein the uplink slot configuration corresponds only to uplink slots.

Aspect 8: The method of Aspect 6, wherein the configuration information further comprises a downlink slot configuration, wherein the resource schedule corresponds only to uplink slots.

Aspect 9: The method of any of Aspects 1-8, wherein the configuration information is indicative of a time division duplex (TDD) frame structure.

Aspect 10: The method of Aspect 9, wherein the TDD frame structure indicates at least one downlink slot, at least one special slot, and at least one uplink slot.

Aspect 11: The method of Aspect 10, further comprising operating in an uplink-only mode, wherein operating in the uplink-only mode comprises refraining from communicating on a downlink slot of the at least one downlink slot and any downlink symbol of the at least one special slot.

Aspect 12: The method of Aspect 9, wherein the TDD frame structure indicates only uplink slots.

Aspect 13: The method of any of Aspects 1-12, wherein the configuration information is indicative of a frequency division duplex frame structure that indicates only uplink slots.

Aspect 14: The method of any of Aspects 1-13, wherein the uplink-only cell is a secondary cell (SCell).

Aspect 15: The method of any of Aspects 1-14, wherein the configuration information is indicative of a medium access control (MAC) based activation configuration, associated with the uplink-only cell, for activating and/or deactivating communications.

Aspect 16: The method of Aspect 15, wherein an activation delay value associated with the MAC based activation configuration is less than an activation delay value for an activation configuration associated with a cell that supports uplink and downlink communications.

Aspect 17: The method of any of Aspects 1-16, wherein the configuration information is indicative of support for simultaneous uplink communication to the uplink-only cell and one or more other cells.

Aspect 18: The method of any of Aspects 1-17, wherein the UE capability information indicates that the UE supports communication with multiple uplink-only cells.

Aspect 19: The method of any of Aspects 1-18, wherein the configuration information indicates that the uplink-only cell does not support spatial relations.

Aspect 20: The method of any of Aspects 1-19, wherein the configuration information indicates that initial access associated with the uplink-only cell is not supported.

Aspect 21: The method of any of Aspects 1-20, wherein the uplink-only cell is associated with a timing advance group (TAG) that includes at least one additional cell, wherein the at least one additional cell supports uplink and downlink communications.

Aspect 22: The method of any of Aspects 1-21, wherein the configuration information is indicative of a hybrid automatic repeat request (HARQ) configuration, the HARQ configuration corresponding only to the uplink-only cell.

Aspect 23: The method of Aspect 22, wherein the HARQ configuration indicates at least one of a HARQ identifier corresponding only to the uplink-only cell or a HARQ procedure corresponding only to the uplink-only cell.

Aspect 24: The method of any of Aspects 1-23, wherein receiving the configuration information comprises receiving at least one of a radio resource control message or a medium access control control element.

Aspect 25: The method of any of Aspects 1-24, further comprising receiving a measurement reference signal for measuring one or more metrics associated with communicating with the uplink-only cell.

Aspect 26: The method of Aspect 25, wherein receiving the measurement reference signal comprises receiving the measurement reference signal from a primary cell or a secondary cell that supports uplink and downlink communications.

Aspect 27: The method of any of Aspects 1-26, further comprising receiving a scheduling communication that schedules one or more uplink resources associated with communicating with the uplink-only cell.

Aspect 28: The method of Aspect 27, wherein receiving the scheduling communication comprises receiving the scheduling communication from a primary cell or a secondary cell that supports uplink and downlink communications.

Aspect 29: A method of wireless communication performed by a network node, comprising: receiving user equipment (UE) capability information indicative of a capability of a UE to support communications with an uplink-only cell, wherein the network node is associated with a primary cell; and transmitting, based on receiving the UE capability information, configuration information corresponding to a carrier aggregation framework including the primary cell and an uplink-only cell.

Aspect 30: The method of Aspect 29, wherein the configuration information indicates a dedicated band number associated only with the uplink-only cell.

Aspect 31: The method of Aspect 29, wherein the configuration information indicates a band number associated with the uplink-only cell, wherein the band number is associated with one or more additional cells.

Aspect 32: The method of any of Aspects 29-31, wherein the configuration information is indicative of a band mode, the band mode comprising a carrier aggregation associated with the primary cell and the uplink-only cell, wherein a band associated with the carrier aggregation comprises a carrier aggregation band associated with uplink and downlink communications or an uplink-only band.

Aspect 33: The method of Aspect 32, wherein the configuration information comprises an explicit indication of the band mode.

Aspect 34: The method of Aspect 32, wherein the configuration information implicitly indicates the band mode based on at least one of an uplink slot configuration or a resource schedule.

Aspect 35: The method of Aspect 34, wherein the uplink slot configuration corresponds only to uplink slots.

Aspect 36: The method of Aspect 34, wherein the configuration information further comprises a downlink slot configuration, wherein the resource schedule corresponds only to uplink slots.

Aspect 37: The method of any of Aspects 29-36, wherein the configuration information is indicative of a time division duplex (TDD) frame structure.

Aspect 38: The method of Aspect 37, wherein the TDD frame structure indicates at least one downlink slot, at least one special slot, and at least one uplink slot.

Aspect 39: The method of Aspect 37, wherein the TDD frame structure indicates only uplink slots.

Aspect 40: The method of any of Aspects 29-39, wherein the configuration information is indicative of a frequency division duplex frame structure that indicates only uplink slots.

Aspect 41: The method of any of Aspects 29-40, wherein the uplink-only cell is a secondary cell (SCell).

Aspect 42: The method of any of Aspects 29-41, wherein the configuration information is indicative of a medium access control (MAC) based activation configuration, associated with the uplink-only cell, for activating and/or deactivating communications.

Aspect 43: The method of Aspect 42, wherein an activation delay value associated with the MAC based activation configuration is less than an activation delay value for an activation configuration associated with a cell that supports uplink and downlink communications.

Aspect 44: The method of any of Aspects 29-43, wherein the configuration information is indicative of support for simultaneous uplink communication to the uplink-only cell and one or more other cells.

Aspect 45: The method of any of Aspects 29-44, wherein the UE capability information indicates that the UE supports communication with multiple uplink-only cells.

Aspect 46: The method of any of Aspects 29-45, wherein the configuration information indicates that the uplink-only cell does not support spatial relations.

Aspect 47: The method of any of Aspects 29-46, wherein the configuration information indicates that initial access associated with the uplink-only cell is not supported.

Aspect 48: The method of any of Aspects 29-47, wherein the uplink-only cell is associated with a timing advance group (TAG) that includes at least one additional cell, wherein the at least one additional cell supports uplink and downlink communications.

Aspect 49: The method of any of Aspects 29-48, wherein the configuration information is indicative of a hybrid automatic repeat request (HARQ) configuration, the HARQ configuration corresponding only to the uplink-only cell.

Aspect 50: The method of Aspect 49, wherein the HARQ configuration indicates at least one of a HARQ identifier corresponding only to the uplink-only cell or a HARQ procedure corresponding only to the uplink-only cell.

Aspect 51: The method of any of Aspects 29-50, wherein transmitting the configuration information comprises transmitting at least one of a radio resource control message or a medium access control control element.

Aspect 52: The method of any of Aspects 29-51, further comprising transmitting a measurement reference signal for measuring one or more metrics associated with communicating with the uplink-only cell.

Aspect 53: The method of any of Aspects 29-52, further comprising transmitting a scheduling communication that schedules one or more uplink resources associated with communicating with the uplink-only cell.

Aspect 54: An apparatus for wireless communication at a device, comprising a processor; memory coupled with the processor; and instructions stored in the memory and executable by the processor to cause the apparatus to perform the method of one or more of Aspects 1-28.

Aspect 55: A device for wireless communication, comprising a memory and one or more processors coupled to the memory, the one or more processors configured to perform the method of one or more of Aspects 1-28.

Aspect 56: An apparatus for wireless communication, comprising at least one means for performing the method of one or more of Aspects 1-28.

Aspect 57: A non-transitory computer-readable medium storing code for wireless communication, the code comprising instructions executable by a processor to perform the method of one or more of Aspects 1-28.

Aspect 58: A non-transitory computer-readable medium storing a set of instructions for wireless communication, the set of instructions comprising one or more instructions that, when executed by one or more processors of a device, cause the device to perform the method of one or more of Aspects 1-28.

Aspect 59: An apparatus for wireless communication at a device, comprising a processor; memory coupled with the processor; and instructions stored in the memory and executable by the processor to cause the apparatus to perform the method of one or more of Aspects 29-53.

Aspect 60: A device for wireless communication, comprising a memory and one or more processors coupled to the memory, the one or more processors configured to perform the method of one or more of Aspects 29-53.

Aspect 61: An apparatus for wireless communication, comprising at least one means for performing the method of one or more of Aspects 29-53.

Aspect 62: A non-transitory computer-readable medium storing code for wireless communication, the code comprising instructions executable by a processor to perform the method of one or more of Aspects 29-53.

Aspect 63: A non-transitory computer-readable medium storing a set of instructions for wireless communication, the set of instructions comprising one or more instructions that, when executed by one or more processors of a device, cause the device to perform the method of one or more of Aspects 29-53.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
transmitting UE capability information indicative of a capability of the UE to support communications with an uplink-only cell;
receiving, from a network node associated with a primary cell and based on transmitting the UE capability information, configuration information corresponding to a carrier aggregation framework including the primary cell and an uplink-only cell; and
transmitting, to a network node associated with the uplink-only cell and based on the configuration information, an uplink communication.

2. The method of claim 1, wherein the configuration information indicates a dedicated band number associated only with the uplink-only cell.

3. The method of claim 1, wherein the configuration information indicates a band number associated with the uplink-only cell, wherein the band number is associated with one or more additional cells.

4. The method of claim 1, wherein the configuration information is indicative of a band mode, the band mode comprising a carrier aggregation associated with the primary cell and the uplink-only cell, wherein a band associated with the carrier aggregation comprises a carrier aggregation band associated with uplink and downlink communications or an uplink-only band.

5. The method of claim 4, wherein the configuration information comprises an explicit indication of the band mode.

6. The method of claim 4, wherein the configuration information implicitly indicates the band mode based on at least one of an uplink slot configuration or a resource schedule.

7. The method of claim 6, wherein the uplink slot configuration corresponds only to uplink slots.

8. The method of claim 6, wherein the configuration information further comprises a downlink slot configuration, wherein the resource schedule corresponds only to uplink slots.

9. The method of claim 1, wherein the configuration information is indicative of a time division duplex (TDD) frame structure.

10. The method of claim 9, wherein the TDD frame structure indicates at least one downlink slot, at least one special slot, and at least one uplink slot.

11. The method of claim 10, further comprising operating in an uplink-only mode, wherein operating in the uplink-only mode comprises refraining from communicating on a downlink slot of the at least one downlink slot and any downlink symbol of the at least one special slot.

12. The method of claim 9, wherein the TDD frame structure indicates only uplink slots.

13. The method of claim 1, wherein the configuration information is indicative of a frequency division duplex frame structure that indicates only uplink slots.

14. The method of claim 1, wherein the uplink-only cell is a secondary cell (SCell).

15. The method of claim 1, wherein the configuration information is indicative of a medium access control (MAC) based activation configuration, associated with the uplink-only cell, for activating and/or deactivating communications, wherein an activation delay value associated with the MAC based activation configuration is less than an activation delay value for an activation configuration associated with a cell that supports uplink and downlink communications.

16. The method of claim 1, wherein the configuration information is indicative of support for simultaneous uplink communication to the uplink-only cell and one or more other cells.

17. The method of claim 1, wherein the UE capability information indicates that the UE supports communication with multiple uplink-only cells.

18. The method of claim 1, wherein the configuration information indicates that the uplink-only cell does not support spatial relations.

19. The method of claim 1, wherein the configuration information indicates that initial access associated with the uplink-only cell is not supported.

20. The method of claim 1, wherein the uplink-only cell is associated with a timing advance group (TAG) that includes at least one additional cell, wherein the at least one additional cell supports uplink and downlink communications.

21. The method of claim 1, wherein the configuration information is indicative of a hybrid automatic repeat request (HARQ) configuration, the HARQ configuration corresponding only to the uplink-only cell, wherein the HARQ configuration indicates at least one of a HARQ identifier corresponding only to the uplink-only cell or a HARQ procedure corresponding only to the uplink-only cell.

22. The method of claim 1, wherein receiving the configuration information comprises receiving at least one of a radio resource control message or a medium access control control element.

23. The method of claim 1, further comprising receiving a measurement reference signal for measuring one or more metrics associated with communicating with the uplink-only cell, wherein receiving the measurement reference signal comprises receiving the measurement reference signal from a primary cell or a secondary cell that supports uplink and downlink communications.

24. The method of claim 1, further comprising receiving a scheduling communication that schedules one or more uplink resources associated with communicating with the uplink-only cell, wherein receiving the scheduling communication comprises receiving the scheduling communication from a primary cell or a secondary cell that supports uplink and downlink communications.

25. A user equipment (UE) for wireless communication, comprising:
a memory; and
one or more processors, coupled to the memory, configured to:
transmit UE capability information indicative of a capability of the UE to support communications with an uplink-only cell;
receive, from a network node associated with a primary cell and based on transmitting the UE capability information, configuration information corresponding to a carrier aggregation framework including the primary cell and an uplink-only cell; and
transmit, to a network node associated with the uplink-only cell and based on the configuration information, an uplink communication.

26. The UE of claim 25, wherein the configuration information indicates a dedicated band number associated only with the uplink-only cell.

27. A non-transitory computer-readable medium storing a set of instructions for wireless communication, the set of instructions comprising:
one or more instructions that, when executed by one or more processors of a user equipment (UE), cause the UE to:
transmit UE capability information indicative of a capability of the UE to support communications with an uplink-only cell;
receive, from a network node associated with a primary cell and based on transmitting the UE capability information, configuration information corresponding to a carrier aggregation framework including the primary cell and an uplink-only cell; and
transmit, to a network node associated with the uplink-only cell and based on the configuration information, an uplink communication.

28. The non-transitory computer-readable medium of claim 27, wherein the configuration information indicates a dedicated band number associated only with the uplink-only cell.

29. An apparatus for wireless communication, comprising:
means for transmitting UE capability information indicative of a capability of the apparatus to support communications with an uplink-only cell;
means for receiving, from a network node associated with a primary cell and based on transmitting the UE capability information, configuration information corresponding to a carrier aggregation framework including the primary cell and an uplink-only cell; and
means for transmitting, to a network node associated with the uplink-only cell and based on the configuration information, an uplink communication.

30. The apparatus of claim 29, wherein the configuration information indicates a dedicated band number associated only with the uplink-only cell.
